(19) United States
(12) Patent Application Publication
(10) Pub. No.: US 2005/0157233 A1
(43) Pub. Date: Jul. 21, 2005

(54) Optical converter module for display system

(76) Inventors: Meng-Chai Wu, Keelung (TW); Chuan-Pei Yu, Yilan County (TW)

Correspondence Address: BAKER & MCKENZIE;PATENT DEPARTMENT, 2001 ROSS AVENUE, SUITE 2300, DALLAS, TX, 75201, US

(21) Appl. No.: 10/758,844

(22) Filed: Jan. 16, 2004

(51) Int. Cl. G02F 1/1335

(52) U.S. Cl. 349/117

(57) ABSTRACT

The present application describes a system and method for converting randomly polarized light into linearly polarized light without absorption loss to improve the brightness of a liquid crystal display system. According one embodiment, the liquid crystal display system includes an optical converter module configured to convert the randomly polarized light into linearly polarized light. The optical converter module is configured to convert the polarization of a first polarized component of the randomly polarized light to be substantially similar to a second polarized component. The optical converter module transmits the first and second polarized components having substantially similar polarization.

### FIELD OF THE INVENTION

The present invention generally relates to display systems, and more particularly, to an optical module for converting light polarization in a display system.

### DESCRIPTION OF THE RELATED ART

FIG. 1 is a schematic view of a conventional liquid crystal display system 100. The system 100 includes a liquid crystal panel 110 and a backlight source 120 placed behind the liquid crystal panel 110. The liquid crystal panel 110 controls the passage of an input light 125 emitted from the backlight source 120. The input light 125 is randomly polarized. The liquid crystal panel 110 includes a liquid crystal layer 112 sandwiched between a front substrate 113 and a rear substrate 114. The front and rear substrates 113 and 114 are transparent substrates. The front substrate 113 can include color filters. A polarizer 116 is coupled to the front substrate 113. The rear substrate 114 includes thin-film transistor elements (not shown) that are configured to apply an electric field to the liquid crystal 112. The electric field controls the orientation of the liquid crystal 112, which modulates the light incident upon the liquid crystal panel 110 for displaying images.

A polarizer 118 is coupled to the rear substrate 114. For the system 100, the input light 125 must to be linearly polarized in a particular orientation plane. The polarizer 118 is configured to transmit a component of the input light 125 that is polarized in the particular orientation plane and absorb components that are not polarized in the particular orientation plane. Because of the partial light absorption by the polarizer 118, the light usage efficiency in the system 100 can only reach up to about 50% of the input light 125 emitted from the light source 120. In some cases, the light usage efficiency can drop below 50% due to light dispersion.

One method to increase the light usage efficiency is to place a dual-brightness enhanced film 130 in combination with a reflector 132 between the light source 120 and the liquid crystal panel 110. The dual-brightness enhanced film 130 is configured to transmit S-polarized components of the input light 125 and reflect P-polarized components of the input light 125 to the reflector 132. The plane of polarization of the S-polarized component of the input light 125 is orthogonal to the plane of incidence of the polarizer 118 and the plane of polarization of the P-polarized component of the input light 125 is parallel to the plane of incidence of the polarizer 118.

Initially, when the input light 125 is incident upon the dual-brightness enhanced film 130, an S-polarized component 127 of the input light 125 is transmitted to the liquid crystal panel 110 and a P-polarized component 128 of the input light 125 is reflected towards the reflector 132. The reflector 132 modulates the P-polarized component 128 and reflects it as a light 129 including both the S-polarized and P-polarized components toward the dual-brightness enhanced film 130. The S-polarized component 127 of the reflected light 129 is transmitted again through the dual-brightness enhanced film 130 and the P- polarized component 128 is reflected to the reflector 132. Using this successive decomposition, the P-polarized component of the input light 125 is converted into S-polarized component and transmitted through the dual-brightness enhanced film 130.

This method improves the light usage efficiency; however, the light absorption still occurs when the P-polarized component 128 is incident upon the reflector 132. This absorption of the P-polarized component 128 can detrimentally affect the brightness of the liquid crystal panel 110. One method to improve the brightness of the liquid crystal panel 110 is to adjust the intensity of the light source 120 by increasing the electric current flowing through the light source 120. However, this increases the power consumption of the display system 100 resulting in a higher thermal and electrical load, which can adversely affect the service life of the light source 120. Therefore, there is a need for a system and method for converting randomly polarized light into linearly polarized light without absorption loss for improving the brightness of a liquid crystal display system.

### SUMMARY OF THE INVENTION

The present application describes a system and method for converting randomly polarized light into linearly polarized light without absorption loss to improve the brightness of a liquid crystal display system. According one embodiment, the liquid crystal display system includes an optical converter module configured to convert the randomly polarized light into linearly polarized light. The optical converter module includes polarizing beam splitters that split the randomly polarized light into a first polarized component and a second polarized component.

When the optical converter module is configured to transmit the first polarized component towards a light modulator, the polarization of the second polarized component is converted to be substantially similar to the polarization of the first polarized component. When the optical converter module is configured to transmit the second polarized component towards the light modulator, the polarization of the first polarized component is converted to be substantially similar to the polarization of the second polarized component. In some embodiments, a light-diffusing layer is provided for scattering the linearly polarized light toward the light modulator. In one embodiment, the polarization of the first and second polarized components is rotated using a retardation element. In some embodiments, the retardation element can be a quarter-wave retardation film. In one embodiment, the light modulator is a liquid crystal panel.

The foregoing is a summary and shall not be construed to limit the scope of the claims. The operations and structures disclosed herein may be implemented in a number of ways, and such changes and modifications may be made without departing from this invention and its broader aspects. Other aspects, inventive features, and advantages of the invention, as defined solely by the claims, are described in the non-limiting detailed description set forth below.

### BRIEF DESCRIPTION OF THE DRAWINGS

FIG. 1 is a schematic view of a conventional display system;

FIG. 2A is a functional block diagram of an exemplary display system according to one embodiment;

FIG. 2B is a schematic cross-sectional view of an exemplary display system according to one embodiment;

FIG. 2C is a perspective view of an exemplary optical converter module according to one embodiment;

FIG. 2D is a top cross-sectional view of the exemplary optical converter module of FIG. 2C;

FIG. 2E is a schematic view illustrating light paths through an exemplary optical converter module according to one embodiment;

FIG. 3A illustrates an exemplary configuration of a converter unit; and

FIG. 3B illustrates yet another exemplary configuration of the converter unit.

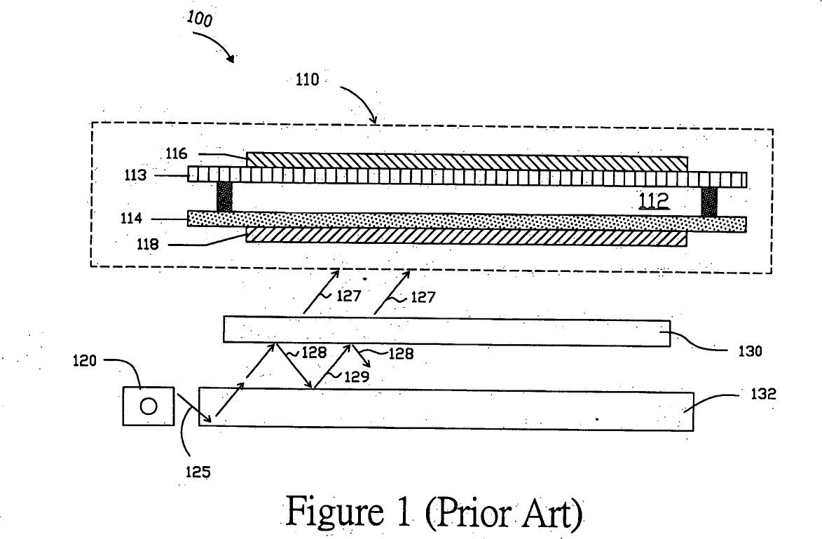

### DETAILED DESCRIPTION OF THE EMBODIMENT(S)

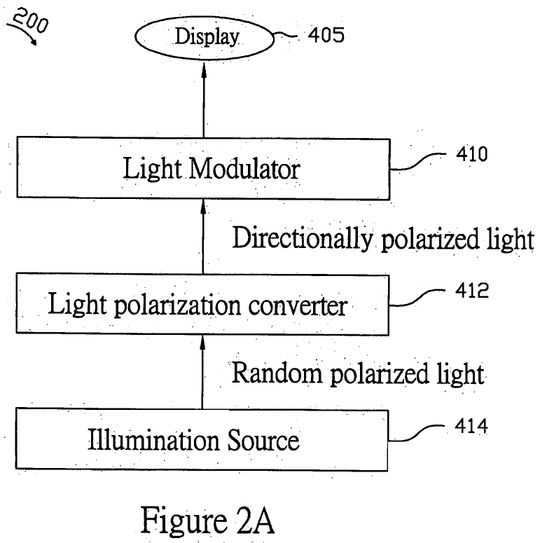

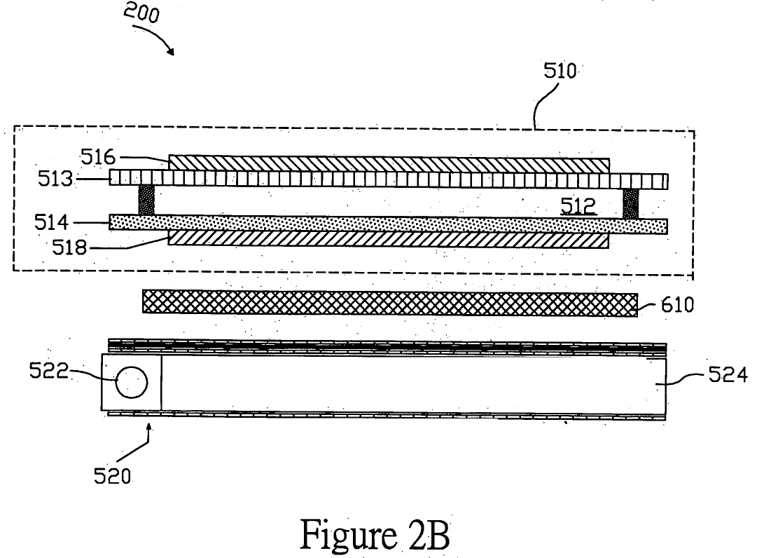

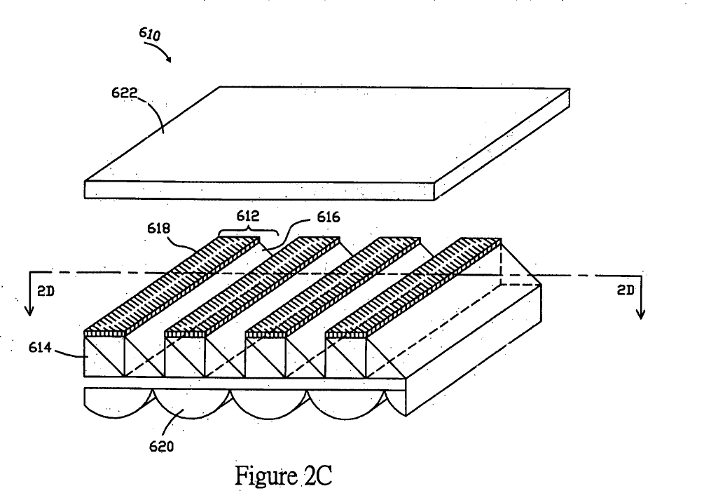

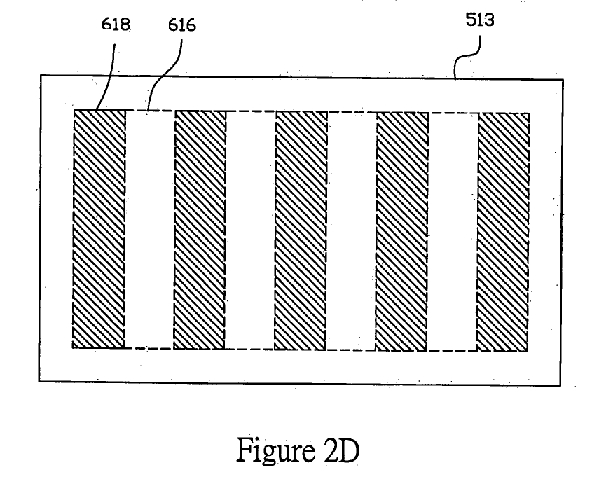

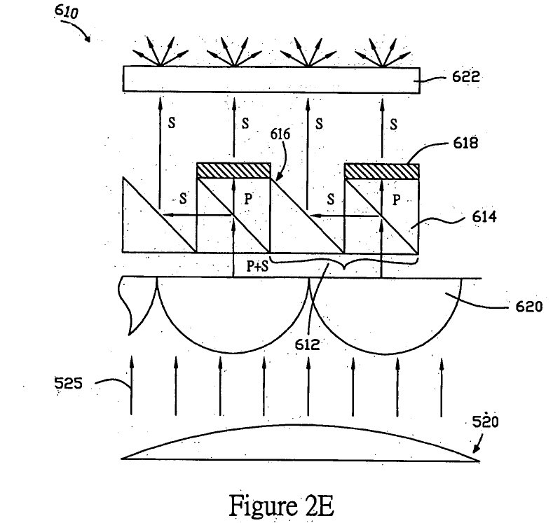

FIG. 2A is a functional block diagram of an exemplary display system 200 according to one embodiment. The display system 200 includes an illumination source 414. In the present example, the illumination source is configured to generate randomly polarized light; however, the illumination source 414 can be configured to generate unpolarized light. When the illumination source 414 is configured to generate unpolarized light, one or more polarizers can be used to convert the unpolarized light into randomly polarized light. A light polarization converter 412 is coupled to the illumination source 414. The light polarization converter 412 is configured to convert the randomly polarized light of the illumination source 414 into linearly polarized light. A light modulator 410 is coupled to the light polarization converter 412. The light modulator 410 is configured to modulate the linearly polarized light for displaying images on a display 405. In the present example, the display 405 is a liquid crystal display panel; however, the display 405 can be any display configured to modulate linearly polarized light for displaying images.

FIG. 2B is a schematic cross-sectional view of the exemplary display system 200 according to one embodiment. The display system 200 includes a light modulator 510. For purposes of illustration, the light modulator 510 is a liquid crystal panel; however, any kind of light modulator can be used for the display system 200. The display system 200 further includes an illumination source 520 placed behind the light modulator 510 and an optical converter module 610 placed between the illumination source 520 and the light modulator 510. In the present example the illumination source 520 is a side-edge (side-light) type backlight source including a cold cathode fluorescent lamp 522 coupled to a light guide plate 524; however, other types of illumination sources can also be used. Alternatively, other types of light-emitting sources can be used in place of the cold cathode fluorescent lamp 522 such as, light-emitting diodes and the like.

In the present example, the light modulator 510 includes a liquid crystal layer 512 sandwiched between a front substrate 513 and a rear substrate 514. The front and rear substrates 513 and 514 can be made of glass, quartz, or other suitable transparent materials. A polarizer 516 is coupled to the front substrate 513 and another polarizer 518 is coupled to the rear substrate 514. The polarizer 518 is configured to transmit a component of incident light that is polarized in a direction orthogonal to its plane of incidence and substantially block all other components of the incident light. The display system 200 further includes an optical converter module 610. The optical converter module 610 is placed between the light modulator 510 and the illumination source 520. The optical converter module 610 is configured to convert randomly polarized incident light output from the illumination source 520 into linearly polarized light substantially without any absorption loss.

FIG. 2C is a perspective view of the optical converter module 610 according to one embodiment. The optical converter module 610 includes an array of converter units 612 placed between an array of lenses 620 and a light-diffusing layer 622. According to one embodiment, the converter units 612 are placed linearly parallel to one another in an array arrangement; however, the converter units 612 can be placed using any layout for uniform illumination of the light modulator 510 (not depicted). In the present example, the lenses 620 are arranged in an array corresponding to the array of the converter units 612. This array arrangement of the lenses 620 and the converter units 612 results in a thinner layer of the optical converter module 610 and provides a uniform illumination of the light modulator 510 (not depicted).

Each converter unit 612 includes a polarizing beam splitter 614, a reflector 616, and a retardation element 618. The reflectors 616 can be formed using any kind of reflective coating on the converter units 612. In the present example, the retardation element 618 is a quarter-wave retardation film configured to perform a 90 degrees rotation on a component of an incident light. The polarizing beam splitter 614 divides randomly polarized light into two orthogonally polarized beams. The lenses 620 have a curvature configured to substantially converge randomly polarized light on each converter unit 612. The lenses 620 can be plano-convex lenses placed parallel to one another in an array aligned with the polarizing beam splitters 614.

FIG. 2D is a top cross-sectional view of the optical converter module 610 through the front substrate 513 showing parallel arrangement of the retardation film 618 and the reflectors 616.

FIG. 2E is a schematic view illustrating light paths through the optical converter module 610 according to one embodiment. The array of lenses 620 directs randomly polarized light 525 from the illumination source 520 towards the polarizing beam splitters 614. The randomly polarized light 525 from the illumination source 520 can be decomposed into as S-polarized component ‘S’ and a P-polarized component ‘P’. The plane of polarization of the P-polarized component ‘P’ is orthogonal to the plane of polarization of the S-polarized component ‘S’. The polarizing beam splitter 614 reflects the S-polarized component ‘S’ towards the reflector 616 and transmits the P-polarized component ‘P’ to the retardation film 618. The S-polarized component ‘S’ is reflected by the reflector 616 towards the light-diffusing layer 622. The P-polarized component ‘P’ is incident upon the retardation film 618. The retardation element 618 rotates the polarization of the P-polarized component ‘P’ by 90° and converts it into the S-polarized component ‘S’. Thus, the light incident upon the light-diffusing layer 622 is substantially linearly polarized in the plane of polarization of the S-polarized component. The light-diffusing layer 622 provides a uniform light output for the light modulator 510. In some embodiments, the distance between the converter units 612 can be varied to adjust the uniformity of the light outputted by the light-diffusing layer 622.

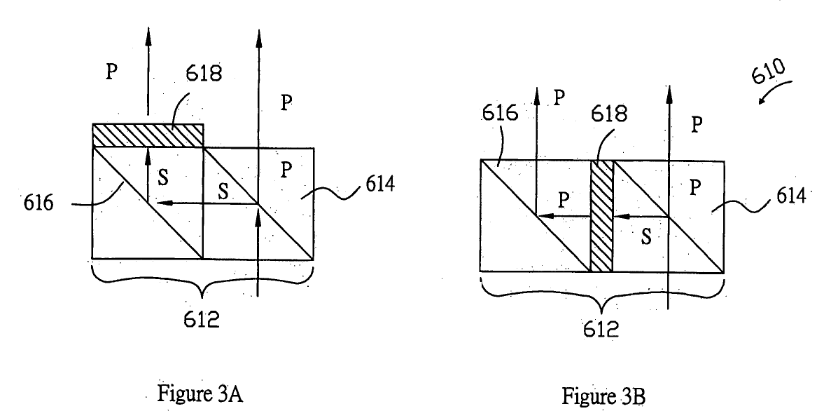

FIG. 3A illustrates another exemplary configuration of the converter unit 612 in the optical converter module 610. In the present example, the retardation element 618 is placed above the reflector 616 to convert the S-polarized component into the P-polarized component. With the exemplary configuration, the optical converter module 610 provides a light that is substantially linearly polarized in the plane of polarization of the P-polarized component.

FIG. 3B illustrates yet another exemplary configuration of the converter unit 612 in the optical converter module 610. In the present example, the retardation element 618 is placed between the reflector 616 and the polarizing beam splitter 614. In the exemplary configuration, the retardation element 618 converts the S-polarized component reflected from the polarizing beam splitter 614 to the P-polarized component before the reflected component is incident upon the reflector 616. Similarly, various configurations can be used to convert randomly polarized light to linearly polarized light without any absorption loss. Thus, a substantial amount of light emitted from the illumination source 520 (not depicted) can reach the light modulator 510 (not depicted). With the exemplary configurations described herein, the brightness of the light modulator 510 can be improved without increasing the power consumption for the illumination source 520.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope of the invention as defined in the claims that follow.

The section headings in this application are provided for consistency with the parts of an application suggested under 37 CFR 1.77 or otherwise to provide organizational cues. These headings shall not limit or characterize the invention(s) set out in any patent claims that may issue from this application. Specifically and by way of example, although the headings refer to a “Field of the Invention,” the claims should not be limited by the language chosen under this heading to describe the so-called field of the invention. Further, a description of a technology in the “Description of Related Art” is not be construed as an admission that technology is prior art to the present application. Neither is the “Summary of the Invention” to be considered as a characterization of the invention(s) set forth in the claims to this application. Further, the reference in these headings to “Invention” in the singular should not be used to argue that there is a single point of novelty claimed in this application. Multiple inventions may be set forth according to the limitations of the multiple claims associated with this patent specification, and the claims accordingly define the invention(s) that are protected thereby. In all instances, the scope of the claims shall be considered on their own merits in light of the specification but should not be constrained by the headings included in this application.

1. A display system, comprising:
a light modulator;
an optical converter module coupled to the light modulator, wherein the optical converter module comprises
a plurality of converter units, wherein one or more of the plurality of converter units comprises:
one or more polarizing beam splitters configured to transmit a first polarized component of an input light and reflect a second polarized component of the input light;
at least one reflector coupled to the one or more polarizing beam splitters and configured to direct the second polarized component towards the light modulator; and
at least one retardation element coupled to one or more of the plurality of polarizing beam splitters and configured to rotate polarization of at least one of the first and second polarized components.

2. A display system according to claim 1, wherein the at least one retardation element is a quarter-wave retardation film.

3. A display system according to claim 1, wherein the plurality of converters units are placed linearly parallel to one another in an array arrangement.

4. A display system according to claim 1, wherein the light modulator is a liquid crystal panel.

5. A display system according to claim 1, wherein the reflector is a polarizing beam splitter.

6. A display system according to claim 1, wherein the at least one retardation element is placed between the at least one reflector and the one or more polarizing beam splitters.

7. A display system according to claim 1, further comprising:
an illumination source coupled to the optical converter and configured to generate the input light.

8. A display system according to claim 7, wherein the illumination source is a backlight unit.

9. A display system according to claim 1, wherein the optical converter module further comprises:
a plurality of lenses coupled to the plurality of converter units and configured to focus the input light towards the one or more polarizing beam splitters.

10. A display system according to claim 9, wherein the lenses are placed linearly parallel to one another in an array arrangement.

11. A display system according to claim 1, wherein the optical converter module further comprises:
at least one light-diffusing layer coupled to the plurality of converter units and configured to scatter light output from the plurality of converter units towards the light modulator.

12. An optical converter module for a display system comprising:
a plurality of converter units, wherein one or more of the plurality of converter units comprises:
one or more polarizing beam splitters configured to transmit a first polarized component of an input light and reflect a second polarized component of the input light;
at least one reflector coupled to the one or more polarizing beam splitters and configured to direct the second polarized component; and
at least one retardation element coupled to one or more of the plurality of polarizing beam splitters and configured to rotate polarization of at least one of the first and second polarized components.

13. An optical converter module according to claim 12, wherein the at least one retardation element is a quarter-wave retardation film.

14. An optical converter module according to claim 12, wherein the plurality of converters units are placed linearly parallel to one another in an array arrangement.

15. An optical converter module according to claim 12, wherein the reflector is a polarizing beam splitter.

16. An optical converter module according to claim 12, wherein the at least one retardation element is placed between the at least one reflector and the one or more polarizing beam splitters.

17. An optical converter module according to claim 12, further comprising:
a plurality of lenses coupled to the plurality of converter units and configured to focus the input light towards the one or more polarizing beam splitters.

18. An optical converter module according to claim 12, further comprising:
at least one light-diffusing layer coupled to the plurality of converter units and configured to scatter light output from the plurality of converter units.

19. A method of modulating light in a display system comprising:
receiving randomly polarized input light;
transmitting a first portion of the randomly polarized input light;
rotating polarization of a second portion of the randomly polarized input light; and
directing the first and second portions of randomly polarized input light to a display panel.

20. A method according to claim 19, wherein the polarization of the second portion of the randomly polarized input light is rotated to be substantially similar to polarization of the first portion of the randomly polarized input light.
